(19) United States
(12) Patent Application Publication
(10) Pub. No.: US 2024/0268471 A1
(43) Pub. Date: Aug. 15, 2024

(54) AEROSOL GENERATING DEVICE FOR CONTROLLING HEATING THROUGH POWER AMPLIFICATION AND OPERATING METHOD THEREOF

(71) Applicant: KT&G CORPORATION, Daejeon (KR)

(72) Inventors: Young Bum KWON, Gyeonggi-do (KR); Dong Sung KIM, Seoul (KR); Yong Hwan KIM, Gyeonggi-do (KR); Hun II LIM, Seoul (KR); Seok Su JANG, Daejeon (KR)

(73) Assignee: KT&G CORPORATION, Daejeon (KR)

(21) Appl. No.: 18/569,523

(22) PCT Filed: Apr. 17, 2023
(86) PCT No.: PCT/KR2023/005179

§ 371 Date: Dec. 12, 2023

(30) Foreign Application Priority Data
Apr. 19, 2022 (KR) 10-2022-0048330
Sep. 28, 2022 (KR) 10-2022-0123474

(51) Int. Cl. A24F 40/50; A24F 40/465; H05B 6/10

(52) U.S. Cl. CPC A24F 40/50; A24F 40/465; H05B 6/108

(57) ABSTRACT

Provided is an aerosol generating device including: a battery configured to supply power; a heating body configured to heat an aerosol generating article; and an amplifier electrically connected to the battery and the heating body, wherein the amplifier is configured to amplify a power signal supplied from the battery using at least two switching elements to generate a first amplification signal, and eliminate a modulation frequency component and a harmonics component from the generated first amplification signal to generate a second amplification signal, and transmit the generated second amplification signal to the heating body, wherein each of the at least two switching elements has a capacitance of 5 nC or less or a resistance value of 15 mΩ or less. In addition, various embodiments identified through the specification are possible.

### TECHNICAL FIELD

The present disclosure relates to an aerosol generating device capable of controlling heating through power amplification using a switching element, and an operating method thereof.

### BACKGROUND ART

Recently, the demand for alternative methods to overcome the shortcomings of general cigarettes has increased. For example, there is an increasing demand for a method of generating aerosol by heating an aerosol generating material in cigarettes or liquid storages, rather than by burning cigarettes.

Recently, studies on a method of heating an aerosol forming material more efficiently in an aerosol generating device that adopts induction heating have been conducted. In particular, because the aerosol generating device is provided in a limited size for user's carrying convenience, a method for improving the efficiency of power in the limited size is required.

### DISCLOSURE

### Technical Problem

One embodiment of the present disclosure may provide an aerosol generating device capable of controlling heating of a heating body by amplifying a power signal by utilizing a class-D-amplifier.

The problems to be solved through embodiments of the present disclosure are not limited to the above-mentioned problems, and problems that are not mentioned will be clearly understood by one of ordinary skill in the art from the specifications and the accompanying drawings.

### Technical Solution

An aerosol generating device according to an embodiment includes a battery configured to supply power, a heating body configured to heat an aerosol generating article, and an amplifier electrically connected to the battery and the heating body, wherein the amplifier may be configured to amplify a power signal supplied from the battery using at least two switching elements to generate a first amplification signal, and eliminate a modulation frequency component and a harmonics component from the generated first amplification signal to generate a second amplification signal, and transmit the generated second amplification signal to the heating body, and each of the at least two switching elements may have a capacitance of 5 nC or less or a resistance value of 15 mΩ or less.

A method of operating an aerosol generating device according to an embodiment includes amplifying a power signal supplied from a battery using at least two switching elements to generate a first amplification signal, eliminating a modulation frequency component and a harmonics component from the generated first amplification signal to generate a second amplification signal, and transmitting the generated second amplification signal to a heating body, wherein each of the at least two switching elements may have a capacitance of 5 nC or less or a resistance value of 15 mΩ or less.

### Advantageous Effects

According to various embodiments of the present disclosure, supply power for induction heating may be efficiently controlled through power amplification, and the size of an aerosol generating device is reduced through efficient power control so that space advantages may be maximized.

However, the effects according to embodiments are not limited to the above-mentioned effects, and effects that are not mentioned will be clearly understood by one of ordinary skill in the art from the specification and the accompanying drawings.

### DESCRIPTION OF DRAWINGS

FIG. 1 is a block diagram of an aerosol generating device according to an embodiment.

FIG. 2 is a flowchart illustrating a signal controlling method of an aerosol generating device according to an embodiment.

FIG. 3 is a circuit diagram of an amplifier according to an embodiment.

FIG. 4 is a block diagram of an aerosol generating device according to an embodiment.

FIG. 5 is a flowchart illustrating a method of correcting an error of the amplifier by using an aerosol generating device according to an embodiment.

FIG. 6 illustrates an example for describing a method of detecting a dead-time of the amplifier.

FIG. 7 illustrates an example for describing a method of correcting an error of the amplifier by using the aerosol generating device of FIG. 4.

FIG. 8 is a cross-sectional view of an aerosol generating device using induction heating according to an embodiment.

FIG. 9 is a cross-sectional view of an aerosol generating device using induction heating according to another embodiment.

FIG. 10 is a block diagram of an aerosol generating device according to another embodiment.

### BEST MODE

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, when an expression such as “at least any one” precedes arranged elements, it modifies all elements rather than each arranged element. For example, the expression “at least any one of a, b, and c” should be construed to include a, b, c, or a and b, a and c, b and c, or a, b, and c.

In an embodiment, an aerosol generating device may be a device that generates aerosols by electrically heating a cigarette accommodated in an interior space thereof.

The aerosol generating device may include a heater. In an embodiment, the heater may be an electro-resistive heater. For example, the heater may include an electrically conductive track, and the heater may be heated when currents flow through the electrically conductive track.

The heater may include a tube-shaped heating element, a plate-shaped heating element, a needle-shaped heating element, or a rod-shaped heating element, and may heat the inside or outside of a cigarette according to the shape of a heating element.

A cigarette may include a tobacco rod and a filter rod. The tobacco rod may be formed of sheets, strands, and tiny bits cut from a tobacco sheet. Also, the tobacco rod may be surrounded by a heat conductive material. For example, the heat conductive material may be, but is not limited to, a metal foil such as aluminum foil.

The filter rod may include a cellulose acetate filter. The filter rod may include at least one segment. For example, the filter rod may include a first segment configured to cool aerosols, and a second segment configured to filter a certain component in aerosols.

In another embodiment, the aerosol generating device may be a device that generates aerosols by using a cartridge containing an aerosol generating material.

The aerosol generating device may include a cartridge that contains an aerosol generating material, and a main body that supports the cartridge. The cartridge may be detachably coupled to the main body, but is not limited thereto. The cartridge may be integrally formed or assembled with the main body, and may also be fixed to the main body so as not to be detached from the main body by a user. The cartridge may be mounted on the main body while accommodating an aerosol generating material therein. However, the present disclosure is not limited thereto. An aerosol generating material may also be injected into the cartridge while the cartridge is coupled to the main body.

The cartridge may contain an aerosol generating material in any one of various states, such as a liquid state, a solid state, a gaseous state, a gel state, or the like. The aerosol generating material may include a liquid composition. For example, the liquid composition may be a liquid including a tobacco-containing material having a volatile tobacco flavor component, or a liquid including a non-tobacco material.

The cartridge may be operated by an electrical signal or a wireless signal transmitted from the main body to perform a function of generating aerosols by converting the phase of an aerosol generating material inside the cartridge into a gaseous phase. The aerosols may refer to a gas in which vaporized particles generated from an aerosol generating material are mixed with air.

In another embodiment, the aerosol generating device may generate aerosols by heating a liquid composition, and generated aerosols may be delivered to a user through a cigarette. That is, the aerosols generated from the liquid composition may move along an airflow passage of the aerosol generating device, and the airflow passage may be configured to allow aerosols to be delivered to a user by passing through a cigarette.

In another embodiment, the aerosol generating device may be a device that generates aerosols from an aerosol generating material by using an ultrasonic vibration method. At this time, the ultrasonic vibration method may mean a method of generating aerosols by converting an aerosol generating material into aerosols with ultrasonic vibration generated by a vibrator.

The aerosol generating device may include a vibrator, and generate a short-period vibration through the vibrator to convert an aerosol generating material into aerosols. The vibration generated by the vibrator may be ultrasonic vibration, and the frequency band of the ultrasonic vibration may be in a frequency band of about 100 kHz to about 3.5 MHz, but is not limited thereto.

The aerosol generating device may further include a wick that absorbs an aerosol generating material. For example, the wick may be arranged to surround at least one area of the vibrator, or may be arranged to contact at least one area of the vibrator.

As a voltage (for example, an alternating voltage) is applied to the vibrator, heat and/or ultrasonic vibrations may be generated from the vibrator, and the heat and/or ultrasonic vibrations generated from the vibrator may be transmitted to the aerosol generating material absorbed in the wick. The aerosol generating material absorbed in the wick may be converted into a gaseous phase by heat and/or ultrasonic vibrations transmitted from the vibrator, and as a result, aerosols may be generated.

For example, the viscosity of the aerosol generating material absorbed in the wick may be lowered by the heat generated by the vibrator, and as the aerosol generating material having a lowered viscosity is granulated by the ultrasonic vibrations generated from the vibrator, aerosols may be generated, but is not limited thereto.

In another embodiment, the aerosol generating device is a device that generates aerosols by heating an aerosol generating article accommodated in the aerosol generating device in an induction heating method.

The aerosol generating device may include a susceptor and a coil. In an embodiment, the coil may apply a magnetic field to the susceptor. As power is supplied to the coil from the aerosol generating device, a magnetic field may be formed inside the coil. In an embodiment, the susceptor may be a magnetic body that generates heat by an external magnetic field. As the susceptor is positioned inside the coil and a magnetic field is applied to the susceptor, the susceptor generates heat to heat an aerosol generating article. In addition, optionally, the susceptor may be positioned within the aerosol generating article.

In another embodiment, the aerosol generating device may further include a cradle.

The aerosol generating device may configure a system together with a separate cradle. For example, the cradle may charge a battery of the aerosol generating device. Alternatively, the heater may be heated when the cradle and the aerosol generating device are coupled to each other.

Hereinafter, the present disclosure will now be described more fully with reference to the accompanying drawings, in which exemplary embodiments of the present disclosure are shown such that one of ordinary skill in the art may easily work the present disclosure. The present disclosure may be implemented in a form that can be implemented in the aerosol generating devices of the various embodiments described above or may be implemented in various different forms, and is not limited to the embodiments described herein.

Hereinafter, embodiments of the present disclosure will be described in detail with reference to the drawings.

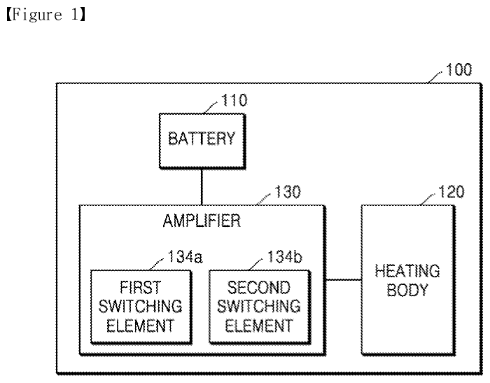

FIG. 1 is a block diagram of an aerosol generating device according to an embodiment.

Referring to FIG. 1, an aerosol generating device 100 may include a battery 110, a heating body 120, and an amplifier 130. However, hardware components in the aerosol generating device 100 are not limited to the illustration of FIG. 1. It will be understood by those skilled in the art that some of the hardware components shown in FIG. 1 may be omitted or a new component may be added according to the design of the aerosol generating device 100.

Hereinafter, the space in which the components of the aerosol generating device 100 are positioned, is not limited, and the operation of each of the components will be described below.

In an embodiment, the battery 110 may supply power required to operate the aerosol generating device 100. For example, the battery 110 may apply a direct current (DC) supply voltage to the amplifier 130, and as a power signal amplified by the amplifier 130 is transmitted to the heating body 120, the heating body 120 may heat at least a portion of an aerosol generating article. In this case, the range of the DC supply voltage applied to the amplifier 130 by using the battery 110 may be about 2.5V to about 10V, and more specifically, about 3V.

In an embodiment, the heating body 120 may heat at least a portion of the aerosol generating article. For example, the heating body 120 may be an induction coil that generates a variable magnetic field in a susceptor included in the aerosol generating article or a susceptor disposed outside the aerosol generating article to heat the susceptor. However, embodiments are not limited thereto, and in another embodiment, the heating body 120 may be a film heater formed of an electrically resistive material.

In an embodiment, the aerosol generating device 100 may further include a resonance circuit for the heating body 120. When the heating body 120 is an induction coil, even when the susceptor disposed inside the induction coil and heated has electrically resistive characteristics, the most part of power applied by the induction coil may have a reactive component for an inductance L of the induction coil. Thus, the aerosol generating device 100 may include a resonance circuit (e.g., an LC matching circuit) to which a capacitor having a capacitance C value is connected so as to offset a reactive power and make a phase power equal to an active power.

A resonance frequency f₀ in the resonance circuit for the heating body 120 may be calculated using Equation 1.

$$\\ \begin{matrix}{f}_{0} = \frac{1}{2 π \sqrt{LC}} & [ Equation 1 ]\end{matrix}$$

That is, the resonance frequency f₀ at which the susceptor may be induction-heated based on material characteristics and electrical characteristics of the susceptor disposed in the heating body 120 (i.e., an induction coil), may be calculated, and components of the resonance circuit may be set based on the calculated resonance frequency f₀.

In an embodiment, the amplifier 130 may receive the power signal supplied from the battery 110 as an input signal and may output the amplified power signal as an output signal through a series of operations.

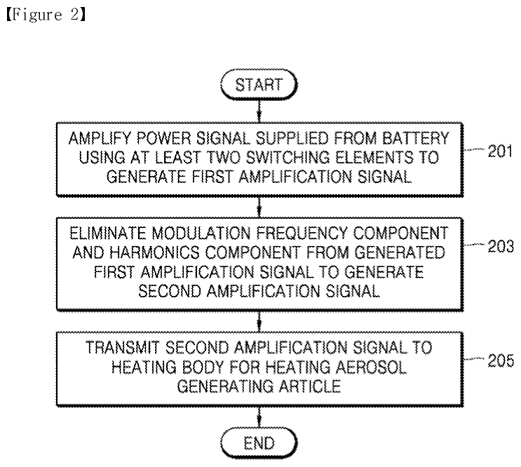

For example, when the amplifier 130 is a class-D power amplifier, the amplifier 130 may receive the power signal based on the DC supply voltage applied from the battery 110 as an input signal. Subsequently, the amplifier 130 may convert the received input signal into a pulse width modulation (PWM) waveform, may amplify the PWM waveform using a switching element, and may output a signal obtained by filtering a modulation frequency component and a harmonics component with respect to the amplified signal as an output signal. A detailed description thereof will be provided below in FIG. 2.

In an embodiment, the amplifier 130 may include switching elements 134a and 134b and may amplify a power signal received as an input signal as the opening/closing states of the switching elements 134a and 134b are converted. For example, the switching elements 134a and 134b may be implemented as transistors that amplify or switch an electronic signal or power. The switching elements 134a and 134b may be one of a field effect transistor (FET) and a bipolar junction transistor (BJT).

Specifically, when the switching elements 134a and 134b are FETs, a DC supply voltage may be applied to gates of the switching elements 134a and 134b, and the switching elements 134a and 134b may control a current between a source and a drain through the applied voltage. Alternatively, when the switching elements 134a and 134b are BJTs, the switching elements 134a and 134b may convert the DC supply voltage applied from the battery 110 into a current and may control a current between a collector and an emitter.

More specifically, the switching elements 134a and 134b may be implemented as FETs such as metal oxide semiconductor field effect transistors (MOSFETs) or metal semiconductor field effect transistors (MESFETs).

In one embodiment, the amplifier 130 may include at least two switching elements (e.g., a first switching element 134a and a second switching element 134b), and the at least two switching elements 134a and 134b may have a capacitance of about 5 nC or less and/or a resistance value of about 15 mΩ or less.

In the case of the class-D power amplifier, when the opening/closing state of one of at least two switching elements included in the amplifier is ON, the opening/closing state of the other one switching element may be OFF. In this case, as a switching frequency indicating an operating speed of the switching element increases, signal delay (ON delay and OFF delay) may occur in the switching element of the amplifier, and a loss in the amplifier due to a dead-time may increase.

In the present disclosure, the “dead-time” may refer to a time required to switch the opening/closing state of another switching element (for example, a high side switch) from OFF to ON from a time point when the opening/closing state of one switching element (for example, a low side switch) of at least two switching elements is switched from ON to OFF.

In an embodiment, the switching frequency in the range of about 500 KHz to about 100 MHz, more preferably, about 6.78 MHz may be applied to the amplifier 130. For example, when the switching frequency in the range of about 6.78 MHz is applied to the amplifier 130, the amplifier 130 includes two switching elements 134a and 134b having a capacitance of about 5 nC or less and/or a resistance value of about 15 mΩ or less so that the dead-time of the amplifier 130 may be minimized, and the power efficiency of the amplifier 130 may be about 90% or more.

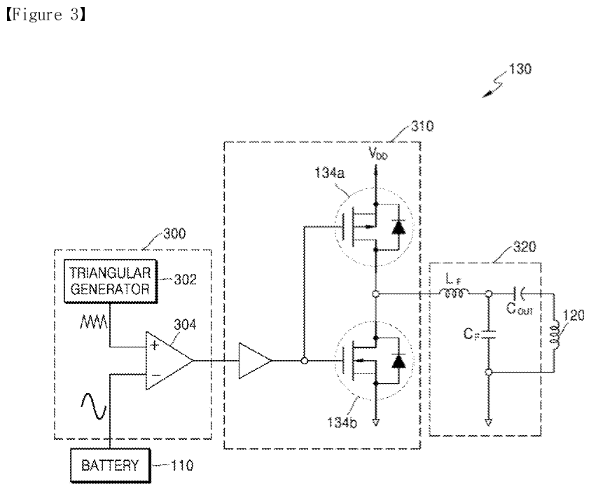

FIG. 2 is a flowchart illustrating a signal controlling method of the aerosol generating device according to an embodiment. FIG. 3 is a circuit diagram of an amplifier according to an embodiment.

Referring to FIGS. 2 and 3, the aerosol generating device (e.g., the aerosol generating device 100 of FIG. 1) may amplify the power signal supplied from the battery 110 using the at least two switching elements 134a and 134b to generate a first amplification signal in operation 201.

In an embodiment, the amplifier 130 may receive the power signal supplied from the battery 110 as an input signal through a pulse width modulation (PWM) processing circuit 300. For example, the amplifier 130 may receive the power signal having a sine waveform as an input signal from the battery 110. Subsequently, the PWM processing circuit 300 of the amplifier 130 may synthesize the power signal received from the battery 110 and a triangular wave generated from the triangular wave generator 302 to convert the synthesized power signal and triangular wave into a PWM waveform having a square waveform. The converted PWM waveform may be transmitted to an amplification circuit 310 of the amplifier 130.

In an embodiment, the amplifier 130 may amplify the converted PWM waveform through the amplification circuit 310 to generate a first amplification signal. For example, the amplification circuit 310 may be a push-pull switching amplification circuit. The amplification circuit 310 may include a first switching element 134a and a second switching element 134b, and the first switching element 134a and the second switching element 134b may have a capacitance of about 5 nC or less and/or a resistance value R_{ds} of about 15 mΩ or less.

As each of the first switching element 134a and the second switching element 134b converts an ON/OFF state, output nodes of the switching elements 134a and 134b may be alternately connected to V_{DD} and ground. Thus, as each of the first switching element 134a and the second switching element 134b alternately converts an ON/OFF state, the first switching element 134a and the second switching element 134b may convert the PWM waveform received from the PWM modulation processing circuit 300 into a first amplification signal. In this case, the ‘first amplification signal’ may mean an amplification signal having an amplified fundamental wave component, an odd harmonics component, and a modulation frequency component.

According to an embodiment, the aerosol generating device 100 may eliminate the modulation frequency component and the harmonics component from the generated first amplification signal to generate a second amplification signal in operation 203.

In an embodiment, the amplifier 130 may eliminate the modulation frequency component and the harmonics component from the first amplification signal generated by a low pass filter 320. For example, an inductor LF and a capacitor CF may be serially connected to the low pass filter 320, and the modulation frequency component and the harmonics component of the first amplification signal may be eliminated by the inductor LF and the capacitor CF. Thus, the low pass filter 320 may convert the first amplification signal into a second amplification signal from which the modulation frequency signal component and the harmonics component are eliminated. In this case, the ‘second amplification signal’ may mean an amplification signal including only the amplified fundamental wave component, unlike the first amplification signal.

According to an embodiment, the aerosol generating device 100 may transmit the generated second amplification signal to a heating body (e.g., the heating body 120 of FIG. 1) for heating the aerosol generating article in operation 205.

In an embodiment, the aerosol generating device 100 may additionally perform output matching before transmitting the generated second amplification signal to the heating body 120. In this case, the ‘output matching’ may mean controlling the frequency of the second amplification signal to control the temperature at which the heating body 120 heats the susceptor, at a certain temperature. For example, the aerosol generating device 100 may control the frequency of the second amplification signal of a resonance frequency (f₀) so that the susceptor may be heated at the maximum temperature.

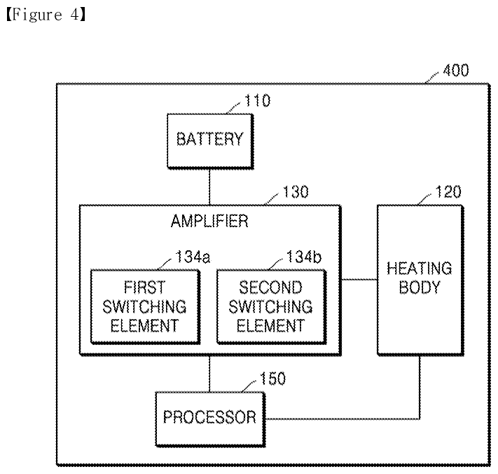

FIG. 4 is a block diagram of an aerosol generating device according to an embodiment.

Referring to FIG. 4, an aerosol generating device 400 may include a battery 110, a heating body 120, an amplifier 130, and a processor 150. However, hardware components in the aerosol generating device 400 are not limited to the illustration of FIG. 4. It will be understood by those skilled in the art that some of the hardware components shown in FIG. 4 may be omitted or a new component may be added according to the design of the aerosol generating device 400. Also, in the description of FIG. 4, contents corresponding to or the same as or similar to those described above may be omitted.

In an embodiment, the battery 110 may supply power required to operate the aerosol generating device 100. For example, the battery 110 may apply a DC supply voltage to the amplifier 130, and as a power signal amplified by the amplifier 130 is transmitted to the heating body 120, the heating body 120 may heat at least a portion of an aerosol generating article. In this case, the range of the DC supply voltage applied to the amplifier 130 by using the battery 110 may be about 2.5V to about 10V, and more specifically, about 3V.

In an embodiment, the heating body 120 may heat at least a portion of the aerosol generating article. For example, the heating body 120 may be an induction coil that generates a variable magnetic field in a susceptor included in the aerosol generating article or a susceptor disposed outside the aerosol generating article to heat the susceptor. However, embodiments are not limited thereto, and in another embodiment, the heating body 120 may be a film heater formed of an electrically resistive material.

In an embodiment, the amplifier 130 may receive the power signal supplied from the battery 110 as an input signal and may output the amplified power signal through a series of operations as an output signal. For example, when the amplifier 130 is a class-D power amplifier, the amplifier 130 may receive the power signal based on the DC supply voltage applied from the battery 110 as an input signal. Subsequently, the amplifier 130 may convert the received input signal into a PWM waveform, may amplify the PWM waveform using a switching element, and may output a signal obtained by filtering a modulation frequency component and a harmonics component with respect to the amplified signal as an output signal.

In an embodiment, the processor 150 may obtain the dead-time of the amplifier 130 to correct the error of the switching elements 134a and 134b.

The amplifier may include a switching element having certain specification information (e.g., a capacitance Qg or a resistance value Rds of 10 mΩ) according to the design of a manufacturer. However, even if a switching element beyond an allowable error range with respect to the certain specification information is manufactured in a process of manufacturing a switching element, it is difficult to determine whether a corresponding error has occurred before acquiring experimental data by applying the switching element to a circuit board. In addition, when a switching element beyond an allowable error range is applied to the circuit board, an amplifier having a lower efficiency than power efficiency of an amplifier targeted by the manufacturer may be manufactured.

Thus, the processor 150 may obtain the dead-time of the amplifier 130 before amplifying the power signal using the amplifier 130 to correct the error of the switching elements 134a and 134b.

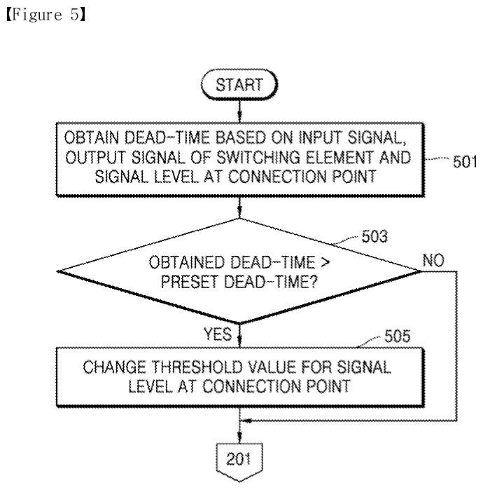

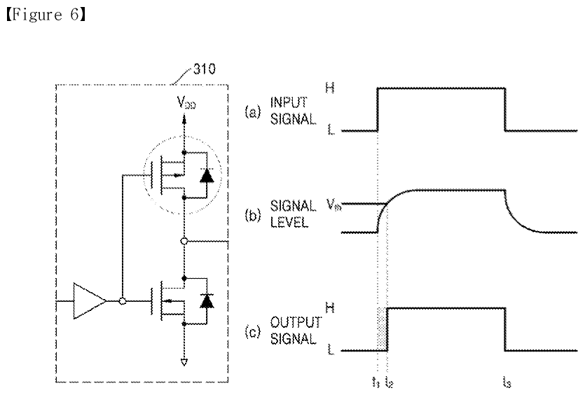

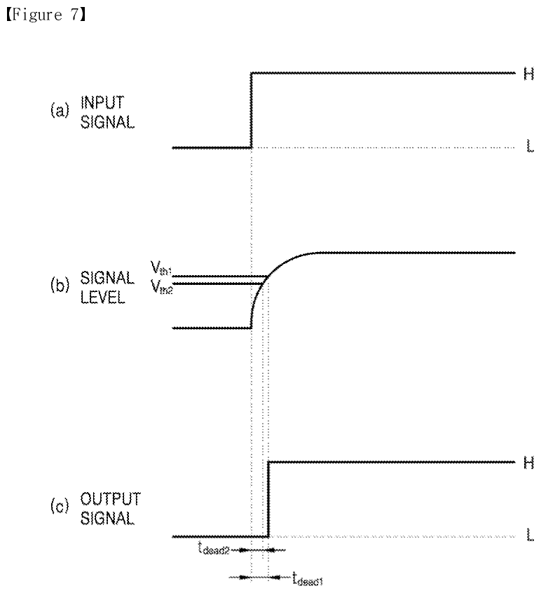

FIG. 5 is a flowchart illustrating a method of correcting an error of the amplifier by using the aerosol generating device according to an embodiment. FIG. 6 illustrates an example for describing a method of detecting the dead-time of the amplifier. FIG. 7 illustrates an example for describing a method of correcting an error of the amplifier by using the aerosol generating device 400 of FIG. 4.

Referring to FIG. 5, a processor (e.g., the processor 150 of FIG. 4) may obtain the dead-time based on an input signal, an output signal, and a signal level at a connection point of the switching elements (e.g., the switching elements 134 and 134b of FIG. 4) in operation 501.

In an embodiment, the processor 150 may obtain the input signal and the output signal of the amplification circuit 310 including two switching elements in the amplifier (e.g., the amplifier 130 of FIG. 4). For example, referring to graph (a) of FIG. 6, when one node of one switching element (e.g., a high side switch) of at least two switching elements of the amplification circuit 310 is connected to V_{DD} and another node thereof is connected to the ground, the processor 150 may obtain that the input signal of the high side switch is converted from a low (L) state to a high (H) state at a time point t₁.

A signal level at a connection point may gradually increase from the time point t₁ in which an input signal of a high side switch is switched from the low (L) state to the high (H) state, and the processor 150 may obtain that an output signal of the high side switch is switched from the low (L) state to the high (H) state at a time point t₂ when the signal level at the connection point reaches a threshold value Vₜₕ. Subsequently, the input signal and the output signal of the high side switch may be simultaneously converted from the high (H) state to the low (L) state at a time point t₃.

That is, a difference between a time point when the input signal of the switching element is converted from the low (L) state into the high (H) state and a time point when the output signal of the switching element is converted from the low (L) state into the high (H) state, may be a dead-time that occurs in the amplifier, and the processor 150 may obtain the dead-time based on the input signal, the output signal of the switching element and the signal level at the connection point.

According to an embodiment, the processor 150 may compare the obtained dead-time with a preset dead-time to determine whether the obtained dead-time exceeds the preset dead-time in operation 503.

For example, the processor 150 may obtain a dead-time t_{dead1} of the switching element included in the amplification circuit 310 to compare the obtained dead-time t_{dead1} with the preset dead-time t_{dead2}. That is, when a first threshold value of the signal level at the connection point in the switching element is Vₜₕ₁, the processor 150 may obtain a time required that, after the input signal of the switching element is converted from the low (L) state into the high (H) state, the input signal of the switching element reaches the threshold value Vₜₕ₁, as the dead-time t_{dead1}.

Subsequently, the processor 150 may compare the obtained dead-time t_{dead1} with the preset dead-time t_{dead2}. In this case, the “preset dead-time t_{dead2}” may mean the maximum dead-time of the switching element set by the manufacturer.

According to an embodiment, when the obtained dead-time exceeds the preset dead-time, the processor 150 may change a threshold value of the signal level at the connection point in operation 505. Also, when the obtained dead-time does not exceed the preset dead-time, the processor 150 may perform operations below operation 201 of FIG. 2.

For example, when the obtained dead-time t_{dead1} is longer than the preset dead-time t_{dead2}, the processor 150 may change a first threshold value Vₜₕ₁ of the signal level at the connection point into a second threshold value Vₜₕ₂ that is a signal level corresponding to the preset dead-time t_{dead2}. In this case, the second threshold value Vₜₕ₂ may be a signal level that is lower than the first threshold value Vₜₕ₁. That is, the processor 150 may change a threshold value of the signal level at the connection point in the switching element from the first threshold value Vₜₕ₁ to a second threshold value Vₜₕ₂ to correct the error of the switching element manufactured beyond an allowable error range.

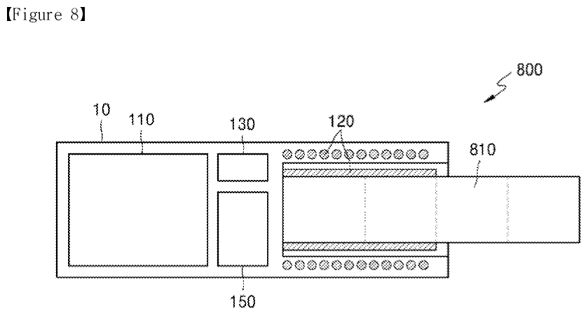

FIG. 8 is a cross-sectional view of an aerosol generating device using induction heating according to an embodiment.

Referring to FIG. 8, an aerosol generating device 800 may include a battery 110, an amplifier 130, a processor 150, and a heating body 120 in a housing 10. In this case, the heating body 120 may include an induction coil and a susceptor. In an embodiment, the housing 10 may include an accommodation space in which an aerosol generating article 810 may be inserted, and the susceptor of the heating body 120 may be disposed to surround at least a portion of the accommodation space.

In an embodiment, the aerosol generating device 800 includes a battery 110 for outputting a power signal and an amplifier 130 for generating an amplification signal to control the induction coil to operate in a certain frequency region (e.g., about 6.78 MHz).

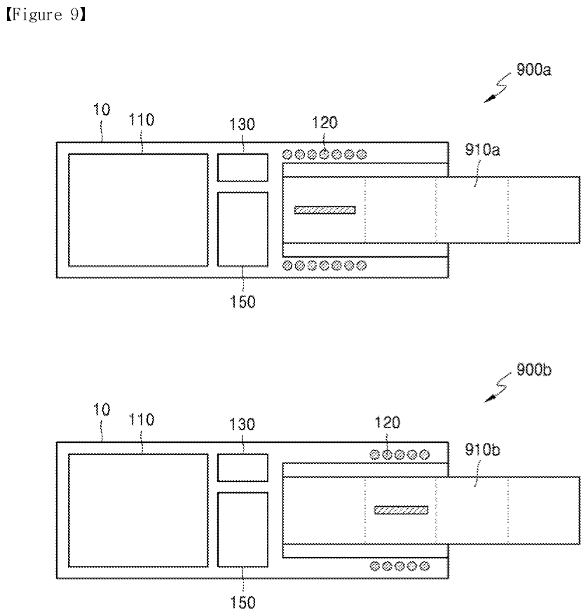

FIG. 9 is a cross-sectional view of an aerosol generating device using induction heating according to another embodiment.

Referring to FIG. 9, an aerosol generating device 900a or 900b may include a battery 110, an amplifier 130, a processor 150, and a heating body 120 in a housing 10. In this case, the heating body 120 may include only an induction coil. In an embodiment, the housing 10 may include an accommodation space in which an aerosol generating article 910a or 910b may be inserted, and the induction coil of the heating body 120 may be disposed to surround at least a portion of the accommodation space. In this case, the induction coil of the heating body 120 may be disposed to correspond to a region in which the susceptor is disposed in the aerosol generating article 910a or 910b.

For example, when the susceptor is included at an upstream end of the aerosol generating article 910a, the induction coil of the heating body 120 may be disposed to surround a bottom end of the accommodation space. In another example, when the susceptor is included in a middle region of the aerosol generating article 910b, the induction coil of the heating body 120 may be disposed to surround a top end of the accommodation space.

However, embodiments are not limited thereto, and in another embodiment, the aerosol generating article may include a susceptor formed of a material such as a metal foil etc., and in this case, the susceptor may be included in the aerosol generating article as a part of a wrapper for surrounding the aerosol generating article.

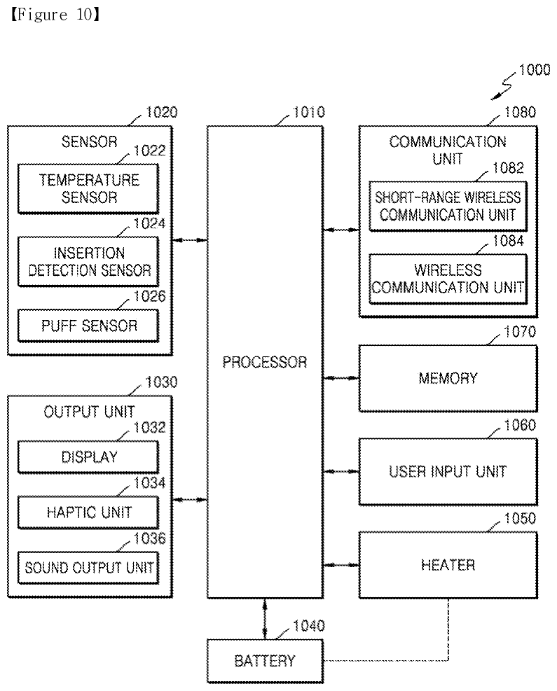

FIG. 10 is a block diagram of an aerosol generating device 1000 according to another embodiment.

The aerosol generating device 1000 may include a controller 1010, a sensing unit 1020, an output unit 1030, a battery 1040, a heater 1050, a user input unit 1060, a memory 1070, and a communication unit 1080. However, the internal structure of the aerosol generating device 1000 is not limited to those illustrated in FIG. 10. That is, according to the design of the aerosol generating device 1000, it will be understood by one of ordinary skill in the art that some of the components shown in FIG. 10 may be omitted or new components may be added.

The sensing unit 1020 may sense a state of the aerosol generating device 1000 and a state around the aerosol generating device 1000, and transmit sensed information to the controller 1010. Based on the sensed information, the controller 1010 may control the aerosol generating device 1000 to perform various functions, such as controlling an operation of the heater 1050, limiting smoking, determining whether an aerosol generating article (e.g., a cigarette, a cartridge, or the like) is inserted, displaying a notification, or the like.

The sensing unit 1020 may include at least one of a temperature sensor 1022, an insertion detection sensor 1024, and a puff sensor 1026, but is not limited thereto.

The temperature sensor 1022 may sense a temperature at which the heater 1050 (or an aerosol generating material) is heated. The aerosol generating device 1000 may include a separate temperature sensor for sensing the temperature of the heater 1050, or the heater 1050 may serve as a temperature sensor. Alternatively, the temperature sensor 1022 may also be arranged around the battery 1040 to monitor the temperature of the battery 1040.

The insertion detection sensor 1024 may sense insertion and/or removal of an aerosol generating article. For example, the insertion detection sensor 1024 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 1026 may sense a user's puff on the basis of various physical changes in an airflow passage or an airflow channel. For example, the puff sensor 1026 may sense a user's puff on the basis of any one of a temperature change, a flow change, a voltage change, and a pressure change.

The sensing unit 1020 may include, in addition to the temperature sensor 1022, the insertion detection sensor 1024, and the puff sensor 1026 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 1030 may output information on a state of the aerosol generating device 1000 and provide the information to a user. The output unit 1030 may include at least one of a display unit 1032, a haptic unit 1034, and a sound output unit 1036, but is not limited thereto. When the display unit 1032 and a touch pad form a layered structure to form a touch screen, the display unit 1032 may also be used as an input device in addition to an output device.

The display unit 1032 may visually provide information about the aerosol generating device 1000 to the user. For example, information about the aerosol generating device 1000 may mean various pieces of information, such as a charging/discharging state of the battery 1040 of the aerosol generating device 1000, a preheating state of the heater 1050, an insertion/removal state of an aerosol generating article, or a state in which the use of the aerosol generating device 1000 is restricted (e.g., sensing of an abnormal object), or the like, and the display unit 1032 may output the information to the outside. The display unit 1032 may be, for example, a liquid crystal display panel (LCD), an organic light-emitting diode (OLED) display panel, or the like. In addition, the display unit 1032 may be in the form of a light-emitting diode (LED) light-emitting device.

The haptic unit 1034 may tactilely provide information about the aerosol generating device 1000 to the user by converting an electrical signal into a mechanical stimulus or an electrical stimulus. For example, the haptic unit 1034 may include a motor, a piezoelectric element, or an electrical stimulation device.

The sound output unit 1036 may audibly provide information about the aerosol generating device 1000 to the user. For example, the sound output unit 1036 may convert an electrical signal into a sound signal and output the same to the outside.

The battery 1040 may supply power used to operate the aerosol generating device 1000. The battery 1040 may supply power such that the heater 1050 may be heated. In addition, the battery 1040 may supply power required for operations of other components (e.g., the sensing unit 1020, the output unit 1030, the user input unit 1060, the memory 1070, and the communication unit 1080) in the aerosol generating device 1000. The battery 1040 may be a rechargeable battery or a disposable battery. For example, the battery 1040 may be a lithium polymer (LiPoly) battery, but is not limited thereto.

The heater 1050 may receive power from the battery 1040 to heat an aerosol generating material. Although not illustrated in FIG. 10, the aerosol generating device 1000 may further include a power conversion circuit (e.g., a direct current (DC)/DC converter) that converts power of the battery 1040 and supplies the same to the heater 1050. In addition, when the aerosol generating device 1000 generates aerosols in an induction heating method, the aerosol generating device 1000 may further include a DC/alternating current (AC) that converts DC power of the battery 1040 into AC power.

The controller 1010, the sensing unit 1020, the output unit 1030, the user input unit 1060, the memory 1070, and the communication unit 1080 may each receive power from the battery 1040 to perform a function. Although not illustrated in FIG. 10, the aerosol generating device 1000 may further include a power conversion circuit that converts power of the battery 1040 to supply the power to respective components, for example, a low dropout (LD0) circuit, or a voltage regulator circuit.

In an embodiment, the heater 1050 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 1050 may be implemented by a metal wire, a metal plate on which an electrically conductive track is arranged, a ceramic heating element, or the like, but is not limited thereto.

In another embodiment, the heater 1050 may be a heater of an induction heating type. For example, the heater 1050 may include a susceptor that heats an aerosol generating material by generating heat through a magnetic field applied by a coil.

The user input unit 1060 may receive information input from the user or may output information to the user. For example, the user input unit 1060 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 10, the aerosol generating device 1000 may further include a connection interface, such as a universal serial bus (USB) interface, and may connect to other external devices through the connection interface, such as the USB interface, to transmit and receive information, or to charge the battery 1040.

The memory 1070 is a hardware component that stores various types of data processed in the aerosol generating device 1000, and may store data processed and data to be processed by the controller 1010. The memory 1070 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 1070 may store an operation time of the aerosol generating device 1000, the maximum number of puffs, the current number of puffs, at least one temperature profile, data on a user's smoking pattern, etc.

The communication unit 1080 may include at least one component for communication with another electronic device. For example, the communication unit 1080 may include a short-range wireless communication unit 1082 and a wireless communication unit 1084.

The short-range wireless communication unit 1082 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 1084 may include a cellular network communication unit, an Internet communication unit, a computer network (e.g., local area network (LAN) or wide area network (WAN)) communication unit, or the like, but is not limited thereto. The wireless communication unit 1084 may also identify and authenticate the aerosol generating device 1000 within a communication network by using subscriber information (e.g., International Mobile Subscriber Identifier (IMSI)).

The controller 1010 may control general operations of the aerosol generating device 1000. In an embodiment, the controller 1010 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

The controller 1010 may control the temperature of the heater 1050 by controlling supply of power of the battery 1040 to the heater 1050. For example, the controller 1010 may control power supply by controlling switching of a switching element between the battery 1040 and the heater 1050. In another example, a direct heating circuit may also control power supply to the heater 1050 according to a control command of the controller 1010.

The controller 1010 may analyze a result sensed by the sensing unit 1020 and control subsequent processes to be performed. For example, the controller 1010 may control power supplied to the heater 1050 to start or end an operation of the heater 1050 on the basis of a result sensed by the sensing unit 1020. As another example, the controller 1010 may control, based on a result sensed by the sensing unit 1020, an amount of power supplied to the heater 1050 and the time the power is supplied, such that the heater 1050 may be heated to a certain temperature or maintained at an appropriate temperature.

The controller 1010 may control the output unit 1030 on the basis of a result sensed by the sensing unit 1020. For example, when the number of puffs counted through the puff sensor 1026 reaches a preset number, the controller 1010 may notify the user that the aerosol generating device 1000 will soon be terminated through at least one of the display unit 1032, the haptic unit 1034, and the sound output unit 1036.

One embodiment may also be implemented in the form of a computer-readable recording medium including instructions executable by a computer, such as a program module executable by the computer. The computer-readable recording medium may be any available medium that may be accessed by a computer and includes both volatile and nonvolatile media, and removable and non-removable media. In addition, the computer-readable recording medium may include both a computer storage medium and a communication medium. The computer storage medium includes all of volatile and nonvolatile media, and removable and non-removable media implemented by any method or technology for storage of information such as computer-readable instructions, data structures, program modules, or other data. The communication medium typically includes computer-readable instructions, data structures, other data in modulated data signals such as program modules, or other transmission mechanisms, and includes any information transfer media.

The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

1. An aerosol generating device comprising:
a battery configured to supply power;
a heating body configured to heat an aerosol generating article; and
an amplifier electrically connected to the battery and the heating body,
wherein the amplifier is configured to:
amplify a power signal supplied from the battery using at least two switching elements to generate a first amplification signal; and
eliminate a modulation frequency component and a harmonics component from the generated first amplification signal to generate a second amplification signal; and
transmit the generated second amplification signal to the heating body, and
wherein each of the at least two switching elements has a capacitance of 5 nC or less or a resistance value of 15 mΩ or less.

2. The aerosol generating device of claim 1, wherein a switching frequency range of the power signal supplied from the battery is 500 KHz to 100 MHz.

3. The aerosol generating device of claim 1, wherein a switching frequency of the power signal supplied from the battery is 6.78 MHz.

4. The aerosol generating device of claim 1, wherein the amplifier comprises:
a pulse width modulation processing circuit configured to generate a pulse width modulation signal from the power signal supplied from the battery;
an amplification circuit comprising the at least two switching elements to which a high-speed switching frequency is applied; and
a low pass filter configured to pass a lower frequency component than a cutoff frequency with respect to the first amplification signal amplified by the amplification circuit to generate the second amplification signal.

5. The aerosol generating device of claim 1, further comprising a processor electrically connected to the amplifier, wherein the processor is configured to obtain a dead-time based on an input signal and an output signal of the switching element and a signal level at a connection point, and when the obtained dead-time is longer than a preset dead-time, the processor is further configured to change a threshold value with respect to a signal level at the connection point.

6. The aerosol generating device of claim 5, wherein the processor is configured to:
obtain a dead-time based on a time point when an input signal of one of the switching elements is converted from a low state into a high state and a time point when a signal level at the connection point reaches a first threshold value; and
when the dead-time is longer than the preset dead-time, change the first threshold value of the signal level at the connection point into a second threshold value that is lower than the first threshold value.

7. The aerosol generating device of claim 1, further comprising a processor electrically connected to the amplifier, wherein the processor is configured to induction-heat a susceptor disposed in the aerosol generating article by using the heating body based on the second amplification signal.

8. The aerosol generating device of claim 1, wherein a processor is electrically connected to the amplifier, wherein the processor is configured to induction-heat a susceptor disposed to surround the aerosol generating article by using the heating body based on the second amplification signal.

9. A method of operating an aerosol generating device, the method comprising:
amplifying a power signal supplied from a battery using at least two switching elements to generate a first amplification signal;
eliminating a modulation frequency component and a harmonics component from the generated first amplification signal to generate a second amplification signal; and
transmitting the generated second amplification signal to a heating body,
wherein each of the at least two switching elements has a capacitance of 5 nC or less or a resistance value of 15 mΩ or less.

10. The method of claim 9, wherein a switching frequency range of the power signal supplied from the battery is 500 KHz to 100 MHz.

11. The method of claim 9, wherein
a switching frequency of the power signal supplied from the battery is 6.78 MHz.

12. The method of claim 9, further comprising obtaining a dead-time based on an input signal and an output signal of the switching element and a signal level at a connection point; and
when the obtained dead-time is longer than a preset dead-time, changing a threshold value with respect to a signal level at the connection point.

13. The method of claim 12, further comprising:
obtaining a dead-time based on a time point when an input signal of one of the switching elements is converted from a low state into a high state and a time point when a signal level at the connection point reaches a first threshold value; and
when the dead-time is longer than the preset dead-time, changing the first threshold value of the signal level at the connection point into a second threshold value that is lower than the first threshold value.

14. The method of claim 9, further comprising induction-heating a susceptor disposed in the aerosol generating article by using the heating body based on the second amplification signal.

15. The method of claim 9, further comprising induction-heating a susceptor disposed to surround the aerosol generating article by using the heating body based on the second amplification signal.
